(19) United States
(12) Patent Application Publication
(10) Pub. No.: US 2013/0293568 A1
(43) Pub. Date: Nov. 7, 2013

(54) IMAGE PROCESSING APPARATUS AND IMAGE PROCESSING PROGRAM PRODUCT

(71) Applicant: Hisashi Sano, Tokyo (JP)

(72) Inventor: Hisashi Sano, Tokyo (JP)

(73) Assignee: NIKON CORPORATION, Tokyo (JP)

(21) Appl. No.: 13/979,912

(22) PCT Filed: Jan. 18, 2012
(86) PCT No.: PCT/JP2012/050962

§ 371 Date: Jul. 16, 2013

(30) Foreign Application Priority Data
Jan. 18, 2011 (JP) 2011-007787

(51) Int. Cl. G09G 5/02

(52) U.S. Cl. CPC G09G 5/028
USPC 345/600

(57) ABSTRACT

An image processing apparatus includes: a luminance/chromaticity calculation unit that calculates a luminance and a chromaticity for each pixel of pixels making up image data, based upon a value indicated for the pixel; a plane calculation unit that determines through arithmetic operation a plane containing coordinates of the pixel in a raw data space; an intersection point calculation unit that ascertains, through calculation, an intersection point at which an achromatic locus and the plane intersect each other in the raw data space; an intersection point chromaticity calculation unit that calculates a chromaticity at the intersection point; and a conversion unit that converts the chromaticity at the pixel to a chromaticity close to a chromaticity of achromatic color if the chromaticity at the pixel is close to the chromaticity at the intersection point.

### TECHNICAL FIELD

The present invention relates to an image processing apparatus and an image processing program product.

### BACKGROUND ART

An image processing apparatus known in the related art sets a straight line (achromatic axis) achieving an achromatic color ratio in a raw data space without imposing any upper limit to A/D conversion. It restores signal data in a saturated signal so as to achieve the achromatic color ratio by projecting the coordinates of the saturated signal onto the straight line and thus minimizes the extent of coloration in an image of an achromatic subject brought up on display at a display unit (patent literature 1).

### CITATION LIST

### Patent Literature

Patent literature 1: Japanese Laid Open Patent Publication No. 2005-318499

### SUMMARY OF THE INVENTION

### Technical Field

However, the image processing apparatus in the related art requires an additional operational step such as exposure adjustment in order to retain the luminance of the overall image when adjusting white point, giving rise to a concern that the operation executed to minimize the extent of coloration in the image of an achromatic subject brought up on display at the display unit may become complex.

### Solution to Problem

According to the 1st aspect of the present invention, an image processing apparatus comprises: a luminance/chromaticity calculation unit that calculates a luminance and a chromaticity for each pixel of pixels making up image data, based upon a value indicated for the pixel; a plane calculation unit that determines through arithmetic operation a plane containing coordinates of the pixel in a raw data space; an intersection point calculation unit that ascertains, through calculation, an intersection point at which an achromatic locus and the plane intersect each other in the raw data space; an intersection point chromaticity calculation unit that calculates a chromaticity at the intersection point; and a conversion unit that converts the chromaticity at the pixel to a chromaticity close to a chromaticity of achromatic color if the chromaticity at the pixel is close to the chromaticity at the intersection point.

According to the 2nd aspect of the present invention, in the image processing apparatus according to the 1st aspect, it is preferred that the image processing apparatus further comprises a locus determining unit that determines the achromatic locus in the raw data space.

According to the 3rd aspect of the present invention, in the image processing apparatus according to the 1st or 2nd aspect, it is preferred that the image processing apparatus, further comprises a display control unit that brings up image data, made up with pixels having undergone conversion via the conversion unit, on display at a display device.

According to the 4th aspect of the present invention, an image processing program product contains an image processing program that enables a computer to execute: a luminance/chromaticity calculation step in which a luminance and a chromaticity are calculated for each pixel of pixels making up image data based upon a value indicated for the pixel; a plane calculation step in which a plane containing coordinates of the pixel in a raw data space is calculated through arithmetic operation; an intersection point calculation step in which an intersection point at which an achromatic locus and the plane intersect each other in the raw data space is ascertained through calculation; an intersection point chromaticity calculation step in which a chromaticity at the intersection point is calculated; and a conversion step in which the chromaticity at the pixel is converted to a chromaticity close to a chromaticity of achromatic color if the chromaticity at the pixel is close to the chromaticity at the intersection point.

According to the 5th aspect of the present invention, in the image processing program product according to the 4th aspect, it is preferred that the image processing program further enables a locus determining step in which the achromatic locus in the raw data space is determined.

According to the 6th aspect of the present invention, in the image processing program product according to the 4th or 5th aspect, it is preferred that the image processing program further enables a display control step in which image data, made up with pixels having undergone conversion through the conversion step, are brought up on display at a display device.

### Advantageous Effect of the Invention

The present invention makes it possible to minimize the extent of coloration in an image of an achromatic subject brought up on display without requiring any complicated operation.

### BRIEF DESCRIPTION OF THE DRAWINGS

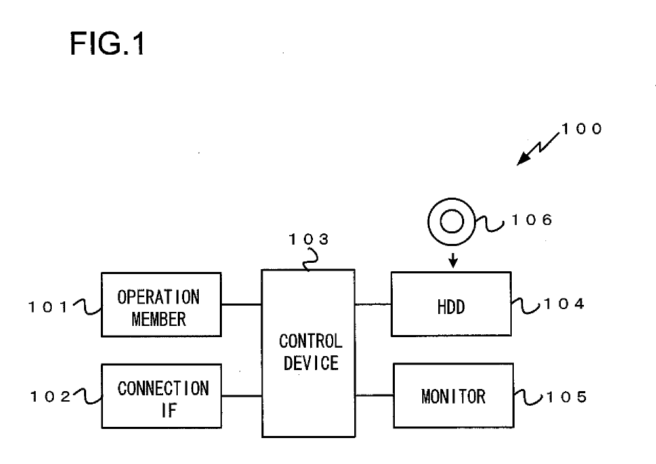

(FIG. 1) A block diagram showing the structure of the personal computer achieved in an embodiment

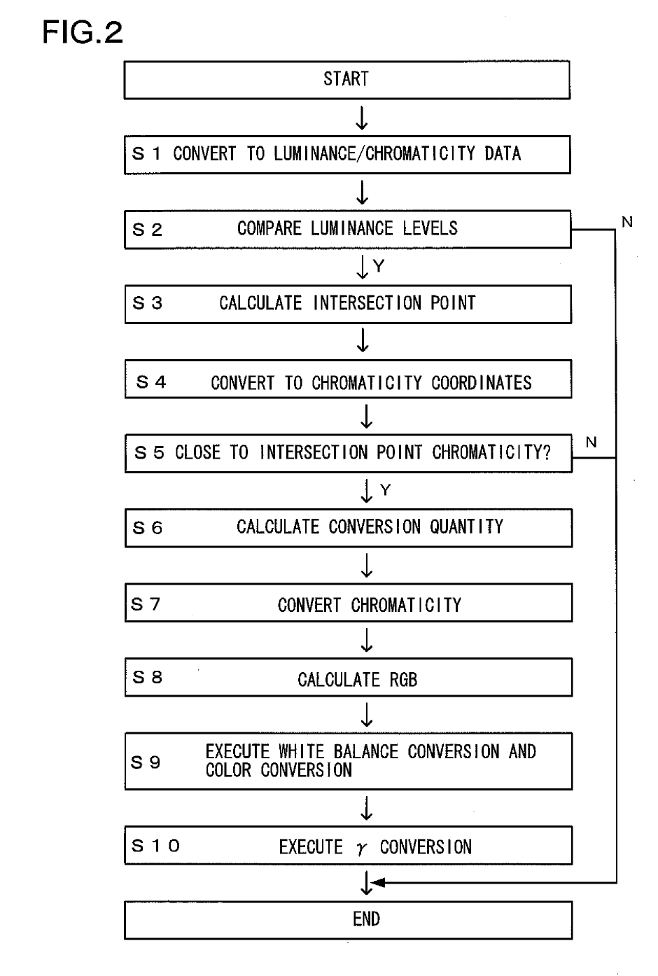

(FIG. 2) A flowchart of the image processing

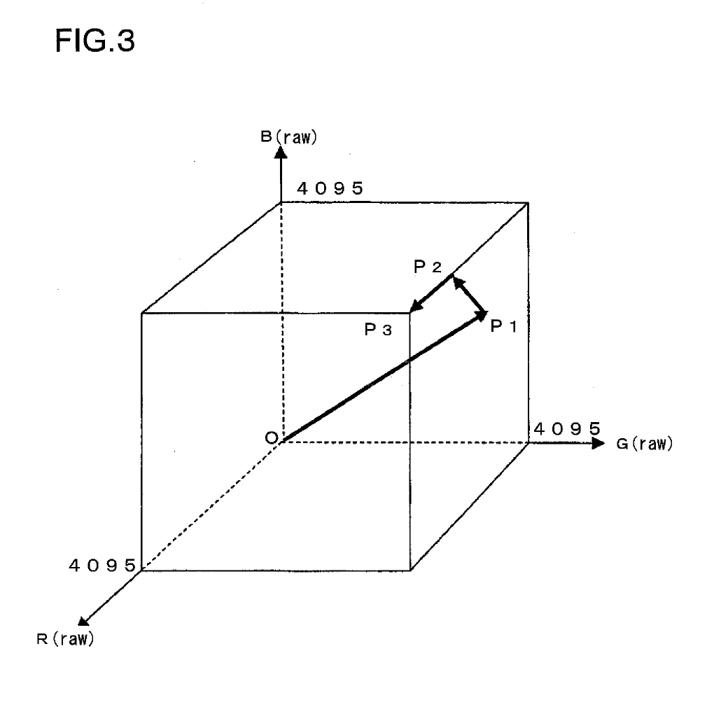

(FIG. 3) A representation of a color space of raw data expressed with R, G and B colors in a coordinate system

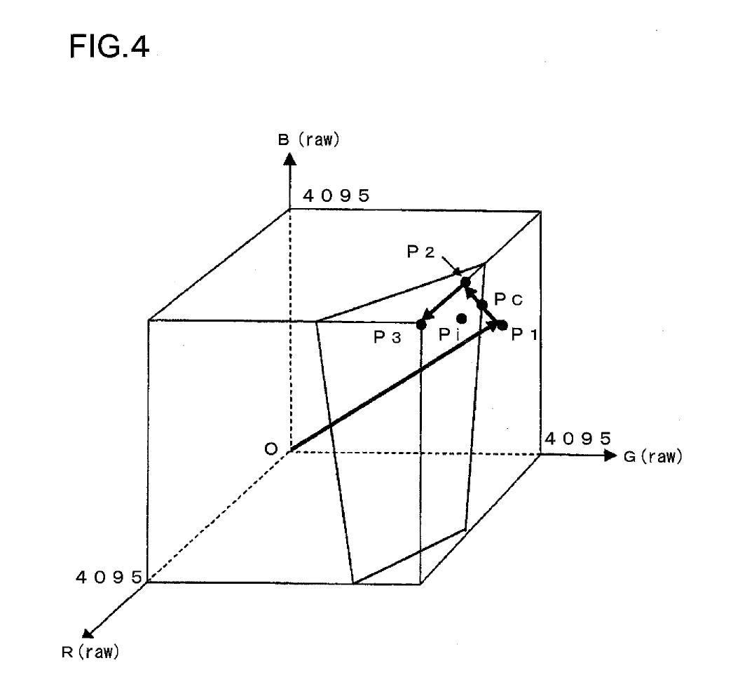

(FIG. 4) An illustration presenting a specific example of an intersection point where a plane, containing pixel coordinates, and an achromatic locus, intersect each other in the raw data space

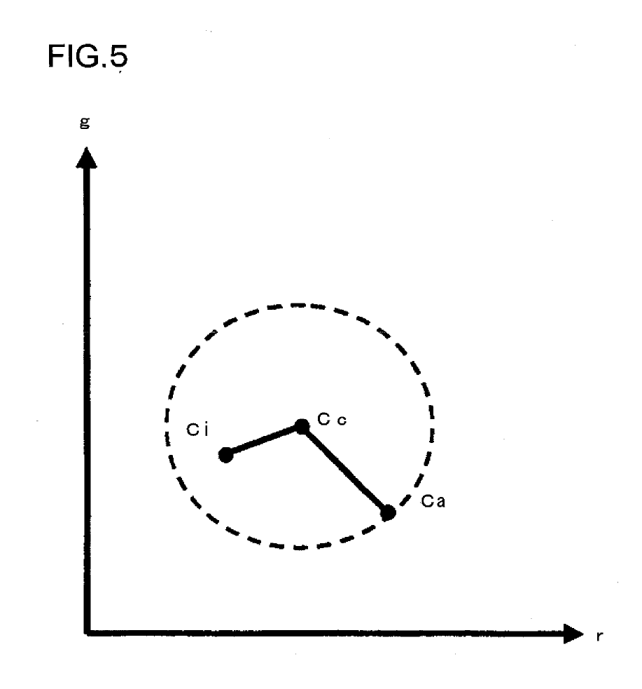

(FIG. 5) A specific example in which a chromaticity point Ci is determined to be near a chromaticity point Cc

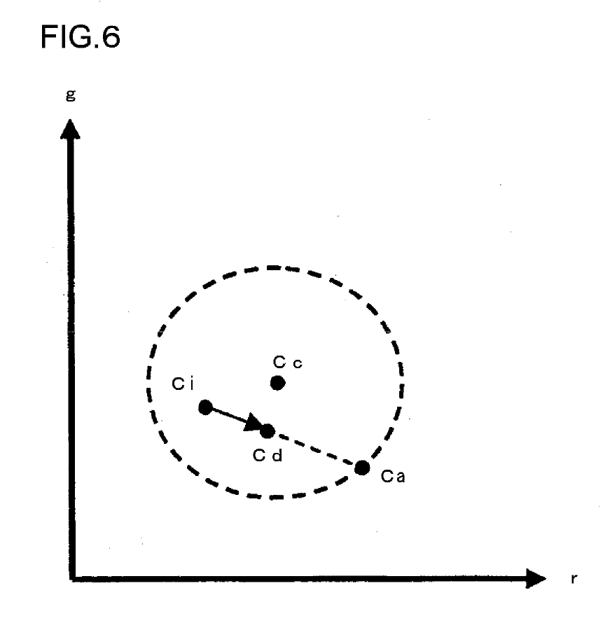

(FIG. 6) A specific example of a chromaticity point Cd to result from conversion

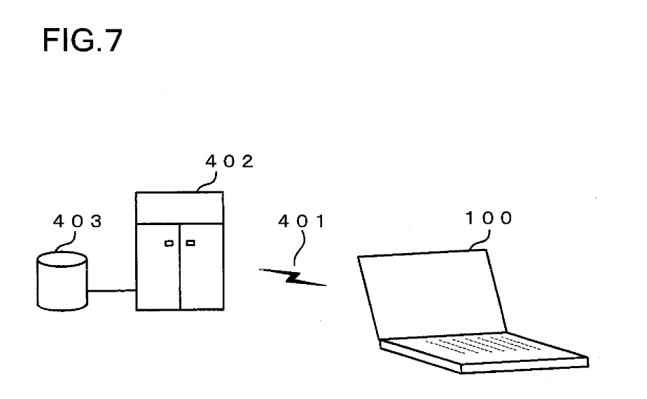

(FIG. 7) An illustration showing how the program may be provided

### DESCRIPTION OF EMBODIMENT

FIG. 1 is a block diagram, showing the structure of the image processing apparatus achieved in an embodiment of the present invention. The image processing apparatus may be, for instance, a personal computer 100, which comprises an operation member 101, a connection IF (interface) 102, a control device 103, and HDD (hard disk drive) 104 and a monitor 105.

The operation member 101 includes various types of devices that are operated by the user, such as a keyboard and a mouse. The connection IF 102 is an interface that enables the personal computer 100 to connect with an external device. The personal computer 100 in the embodiment can be connected with a digital camera via the connection IF 102 so as to take in image files obtained through photographing operations executed at the digital camera. It is to be noted that the connection IF 102 may be a USB interface that allows the personal computer 100 to connect with a digital camera through wired connection or a wireless LAN module that allows the personal computer 100 to connect with the digital camera through wireless connection.

The control device 103, constituted with a CPU, a memory and other peripheral circuits, controls the personal computer 100 as a whole. It is to be noted that the memory constituting part of the control device 103 is a volatile memory such as an SDRAM. The memory includes a work memory where a program is opened when the CPU executes the program and a buffer memory where data are temporarily recorded.

The HDD 104 is a recording device where image files having been taken in via the connection IF 102, data of various programs executed by the control device 103 and the like are recorded. It is to be noted that program data, to be recorded in the HDD 104, are provided in a storage medium 106 such as a CD-ROM or a DVD ROM. Once the user installs the program data recorded in the storage medium 106 into the HDD 104, the control device 103 is able to execute the corresponding program. An image display application program enabling image display is installed in advance in the HDD 104 in the embodiment. At the monitor 105, which may be, for instance, a liquid crystal monitor, various types of display data output from the control device 103 are brought up on display.

When displaying an image of an achromatic subject at the monitor 105, the control device 103 in the personal computer 100 in the embodiment executes processing so as to prevent coloration of the achromatic subject in the image brought up on display. The following is a description of how an image of an achromatic subject may become colored.

A digital camera used to capture an image often obtains image signals corresponding to three colors, R, G and B via an image sensor where light having been transmitted through R, G and B color filters, undergo photoelectric conversion. The image signals thus obtained, commonly referred to as raw data, further undergo conversion processing such as Bayer interpolation, white balance conversion, matrix conversion and γ conversion so as to generate image data optimized for viewing at a display unit such as the monitor 105 and the optimized image data resulting from the conversion are saved as JPEG data.

Human visual perception of an achromatic subject and a digital camera operation executed to capture an image of an achromatic subject will now be examined. First, visual perception of an achromatic subject by a human will be considered. When a person looks at an achromatic subject such as gray card (an object having substantially uniform reflectance over the visible light range), his visual perception normally adapts to the color of the light source, and the person perceives that the subject is an achromatic object even if the light source changes. In other words, regardless of whether the light source emits bluish light or reddish light, the person feels that he is looking at an achromatic object, as long as the object achieves substantially uniform reflectance over the visible light range. In addition, when the person views an image brought up on display, he perceives the image as an achromatic image if the RGB signals achieve a uniform ratio (1:1:1). This means that when displaying a photographic image of an achromatic subject on a display unit, it is desirable that the display signals sustain the RGB ratio of (1:1:1) even if the light source changes.

Next, the process of capturing an image of an achromatic subject and generating raw data on a digital camera will be examined An achromatic subject achieves substantially uniform reflectance over the visible light range and thus, light reflected off the achromatic subject takes on the characteristics of the light source. The raw data obtained by capturing an image of such an achromatic subject, in turn, are bound to take on the color characteristics of the reflected light. In addition, the characteristics of the raw data are also dependent upon the spectral sensitivity of the image sensor in the digital camera. In other words, the RGB ratio of the raw data obtained by capturing an image of an achromatic subject are determined in correspondence to the color characteristics of the light source and the spectral sensitivity of the image sensor and thus, the uniform ratio (1:1:1) will not be achieved under normal circumstances. If this image is directly brought up on display at a display unit, it will not be perceived as an achromatic image.

This issue is addressed by executing white balance processing on the raw data expressing a photographic image of an achromatic subject as part of the optimization processing for optimizing the raw data for viewing on the display unit. The white balance processing is executed based upon information indicating the color characteristics of the light source and the spectral sensitivity of the image sensor by multiplying the individual channels in the raw data by different gain values. Through this processing, the RGB ratio of the raw data is adjusted to 1:1:1 and, as a result, the user viewing the image on display at the display unit is able to perceive the image as an achromatic image.

The saturation of the raw data, and more specifically, the saturation of the raw data signals, which is bound to occur as the luminance of the achromatic subject changes, will be examined next. A raw data signal takes on a higher value as the subject luminance increases but it never exceeds 4095 at the A/D conversion upper limit of, for instance, 12 bits. At a luminance exceeding 4095 (i.e., when saturation occurs), a signal value of 4095 is recorded.

As explained earlier, raw data expressing an image of an achromatic subject do not normally achieve the ratio of 1:1:1. The following description will be given by assuming that the raw data achieve RGB ratio of 0.6:1.0:0.8. As the achromatic subject, initially assuming low luminance, becomes increasingly brighter, the G channel achieving the largest value of 1.0 in the ratio, among the various channels, first becomes saturated and subsequently, the other channels become saturated in the order of; the B channel and the G channel. The ratio of the saturated raw data is different from 0.6:1.0:0.8.

In the white balance processing mentioned earlier, gain values determined based upon the ratio 0.6:1.0:0.8 are applied. This means that while a signal that has not been saturated is rendered to achromatic data, a saturated signal is not rendered to achromatic data. Consequently, an image taking on some coloration will be brought up on display at the display unit even though the image has been obtained by capturing an achromatic subject.

The control device 103 in the embodiment addresses the issue discussed above through the processing executed as shown in FIG. 2. FIG. 2 presents a flowchart of the image processing executed in the embodiment. The processing in FIG. 2 is executed by the control device 103 as a program started up in response to a user instruction for image display at the monitor 105. It is to be noted that the processing executed in the embodiment is described by assuming that the user has selected one of the image files recorded in the HDD 104 as a display target and that the control device 103 executes the processing shown in FIG. 2 by reading out image data, e.g., raw RGB data, from the display target image file.

In preparation for the image conversion executed in the embodiment through the processing shown in FIG. 2, the achromatic locus in the raw data space is calculated in advance. The methods adopted when calculating the achromatic locus in the raw data space will be described next. FIG. 3 shows the color space of raw data expressed with R, G and B colors, represented on a coordinate system. The following description will be provided by assuming that the raw data are 12-bit data. This means that sets of various color data each take a value in the range of 0 through 4095 and that the range of values that the raw data may assume is defined as the space within the cube shown in FIG. 3.

A locus O P1 P2 P3 indicated by the arrows in FIG. 3 represents achromatic data within the cube. In the description of the embodiment, the locus O P1 P2 P3 indicating the achromatic data within the cube will be referred to as an achromatic locus. This achromatic locus can be determined as described below based upon the RGB ratio of raw data obtained by capturing a photographic image of, for instance, a gray card. It is to be noted that the following description is given by assuming that the RGB ratio is 0.6:1.0:0.8 and that the achromatic luminance, initially at a low level in the raw data, gradually increases.

Assuming that the achromatic luminance, initially at the origin point O, increases, a locus O P1, made up with the points sustaining the RGB ratio within the space shown in FIG. 3, forms part of the achromatic locus. The G channel data become saturated at the terminating end P1. The coordinates of P1 are calculated to be P1 (2457, 4095, 3276), as expressed in (1) through (3).

R=0.6×4095=2457 (1)

G=1.0×4095=4095 (2)

B=0.8×4095=3276 (3)

Once the luminance increases to a level beyond P1, only the values indicated in the R channel data and the B channel data increase by sustaining the ratio, since the G channel data have been saturated. A locus P1 P2 made up with points sustaining the ratio, form part of the achromatic locus. Following saturation of the G channel data, the B channel data become saturated. The value taken for the R channel data when the B channel data become saturated is calculated as expressed in (4) below. Namely, the coordinates of P2 are calculated to be P2 (3071, 4095, 4095).

R−4095×(0.6/0.8)=3071 (4)

After the luminance increases to a level beyond P2, only the R channel data continues to take on increasing values, since the G channel data and the B channel data have already been saturated. Thus, the locus P2 P3 forms part of the achromatic locus. The coordinates of P3 are calculated to be P3 (4095, 4095, 4095). The locus O P1 P2 P3 calculated as described above constitutes the achromatic locus. The achromatic locus may be dynamically calculated by recognizing the white balance data following the photographing operation or it may be calculated and recorded into the HDD (storage unit) 104 in advance. It is to be noted that the achromatic locus may be calculated in advance in correspondence to each specific type of light source (e.g., a fluorescent lamp, an incandescent light bulb, flash lamp or the like), such achromatic loci calculated in advance may be stored into the storage unit of the image processing apparatus in the embodiment during the image processing apparatus manufacturing process and then the achromatic locus to be used in the conversion processing, which will be described in detail later, may be selected in correspondence to the illuminating light source used when capturing the image, among the achromatic loci stored in the storage unit.

Next, the processing in the flowchart shown in FIG. 2 will be explained. In step S1, the control device 103 converts the display target raw RGB data to luminance/chromaticity data. The explanation will be given by assuming that the raw RGB data have already undergone Bayer interpolation and thus, each pixel holds data corresponding to the three channels R, G and B. The control device 103 converts the raw RGB data to luminance data as expressed in (5) below, which indicates the relationship between the raw RGB data and the luminance Y. It is to be noted that s, t and u in expression (5) below are values determined through optimization of values obtained by executing photographing operation and color metering operation in advance. With (Ri, Gi, Bi) representing the raw RGB data at a target pixel Pi, the luminance Yi at the target pixel Pi can be calculated through conversion as expressed in (5) below.

Y=sR+tG+uB (5)

In addition, the control device 103 calculates chromaticity values as expressed in (6) and (7) below. The chromaticity values calculated in this embodiment represent rg chromaticity and the chromaticity values ri and gi at the target pixel Pi can be calculated by using (Ri, Gi, Bi) for substitution in expressions (6) and (7) below.

r=R/(R+G+B) (6)

g=G/(R+G+B) (7)

The operation then proceeds to step S2, in which the control device 103 compares the luminance Yi at the target pixel Pi, having been calculated through step S1, with a luminance value Yp1 at P1 in FIG. 3. Yp1 can be calculated by substituting the coordinates of P1 for R, G and B in expression (5). If the comparison results indicate that Yi≦Yp1, the control device 103 judges that the chromaticity conversion according to the present invention does not need to be executed and ends the processing. However, if Yi>Yp1, the operation proceeds to step S3.

In step S3, the control device 103 calculates the luminance Yp2 at P2. Yp2 can be determined by substituting the coordinates of P2 for R, G and B in expression (5). If the relationship between Yi and Yp2 is such that Yi≦Yp2 is true, the control device 103 determines the intersection point at which a plane Yi=sR+tG+uB and the line segment P1 P2 intersect each other. If, on the other hand, Yi>Yp2 is true, the control device 103 determines the intersection point at which the plane Yi=sR+tG+uB and the line segment P2 P3 intersect each other. It is to be noted that the points present on the plane expressed as Yi=sR+tG+uB in the raw RGB space assume a luminance level equal to that at the point Pi (Ri, Gi, Bi) and accordingly, the intersection point at which this plane and the achromatic locus intersect each other is determined through step S3. In other words, the intersection point, present on the achromatic locus, achieves a luminance level equal to that at Pi. In FIG. 4, the intersection point determined at this time is indicated as Pc.

Subsequently, the operation proceeds to step S4 in which the control device 103 determines a chromaticity point Ci at the target pixel Pi, a chromaticity point on the achromatic locus, i.e., a chromaticity point Cc corresponding to the intersection point Pc having been determined through calculation in step S3, and an achromatic color chromaticity point Ca. In more specific terms, these chromaticity points may each be calculated by substituting the corresponding R, G and B coordinates for R, G and B in expressions (6) and (7). It is to be noted that the chromaticity point Ca should be calculated by substituting the R, G and B coordinates of a point on the line segment O P1 (e.g., P1) for R, G and B in expressions (6) and (7). The operation then proceeds to step S5.

In step S5, the control device 103 makes a decision as to whether or not the chromaticity point Ci at the target pixel Pi is present near the chromaticity point Cc on the achromatic locus. In this step, the control device 103 may decide that the chromaticity point Ci is close to the chromaticity point Cc if, for instance, the relationship expressed as in (8) below is true, as indicated in FIG. 5. Upon deciding in step S5 that the chromaticity point Ci is located near the chromaticity point Cc, the operation proceeds to step S6. If, on the other hand, it is decided that the chromaticity point Ci is not near the chromaticity point Cc, the processing ends.

C̅_̅{̅c̅}̅C̅ᵢ̅≦ C̅_̅{̅c̅}̅C̅ₐ̅ (8)

In step S6, the control device 103 calculates a conversion quantity t, indicating the extent of conversion to be applied in conjunction with the chromaticity point Ci at the target pixel Pi, as expressed in (9) below, before the operation proceeds to step S7.

$$t = 1 - m ( m = \frac{\overline{{C}_{c} {C}_{i}}}{\overline{{C}_{c} {C}_{a}}} ) \qquad ( 9 )$$

In step S7, the control device 103 converts the chromaticity point Ci at the target pixel Pi to a chromaticity point Cd by using the conversion expression in (10) below. As a result, the chromaticity point Ci at the target pixel Pi is converted to the conversion result, i.e., the chromaticity point Cd, as indicated in FIG. 6. Through this process, the chromaticity at a point located near the achromatic locus is converted to a chromaticity close to achromatic color chromaticity while retaining the gradation.

\vec{CᵢC_{d}}=t·\vec{CᵢCₐ} (10)

Subsequently, the operation proceeds to step S8, in which the control device 103 calculates values to be taken for R, G and B based upon the conversion result, i.e., the chromaticity point Cd (rd, gd), and the luminance Yi at the target pixel Pi. In step S8, the control device 103 first calculates Rd, Gd and Bd as expressed in (12) through (14) below by using k, which, in turn, is determined as expressed in (11) below.

k=Yi/[s·rd+t·gd+u·(1−rd−gd)] (11)

Rd=k·rd (12)

Gd=k·gd (13)

Bd=k·(1−rd−gd) (14)

The operation then proceeds to step S9, in which the control device 103 executes white balance conversion and color conversion on Rd, Gd and Bd having been calculated through step S8. For example, the control device 103 may execute white balance conversion and color conversion by using, for instance, a 3×3 matrix calculated based upon the condition of the light source for the photographing operation, the spectral sensitivity at the image sensor, the display characteristics and the like. Subsequently, the operation proceeds to step S10, in which the control device 103 executes gradation conversion optimal for the γ characteristics of the monitor 105. In other words, the control device 103 executes γ conversion. Upon executing the processing in steps S1 through S10 described above for all the pixels, the control device 103 ends the processing.

The control device 103 outputs the image data resulting from the processing in steps S1 through S10 having been executed for all the pixels to the monitor 105 so as to display the image at the monitor 105.

Through the embodiment described above, the following advantage is achieved. The control device 103 makes a decision as to whether or not the chromaticity point Ci at the target pixel Pi is located near the chromaticity point Cc on the achromatic locus, and upon deciding that the chromaticity point Ci is located near the chromaticity point Cc, it converts the chromaticity point Ci at the target pixel Pi to the chromaticity point Cd. Through this process, the chromaticity at a point present on the chromaticity locus is converted to achromatic color chromaticity. In addition, the chromaticity at a point near the achromatic locus is converted to a chromaticity close to achromatic color chromaticity while retaining gradation. As a result, the extent of coloration occurring as a result of raw data saturation over a high luminance image area can be minimized.

—Variations—

It is to be noted that the image processing apparatus achieved in the embodiment as described above allows for the following variations.
(1) The image processing achieved in the embodiment described above is realized with a personal computer 100. However, the present invention is not limited to this example and may be adopted in other types of apparatuses such as a portable terminal and a digital camera, at which images are brought up on display.
(2) In the embodiment described above, image data resulting from the image processing are output and displayed at the monitor 105. However, the present invention is not limited to this example and may be adopted in conjunction with data output to a device other than a display device. For instance, it may be adopted in conjunction with image data having undergone image processing, which are output to a printer or the like.
(3) In the embodiment, an image processing program enabling the image processing described above is provided via the storage medium 106, in which the program is recorded. However, the program may be provided in a data signal transmitted via the Internet or the like. FIG. 7 shows how the program may be provided in such alternative modes. The personal computer 100 is capable of establishing a connection with a communication line 401. A computer 402 is a server computer that provides the program stored in a storage medium such as a hard disk 403. The communication line 401 may be a communication line enabling Internet communication, personal computer communication or the like, or it may be a dedicated communication line. The computer 402 reads out the program from the hard disk 403 and transmits the program to the personal computer 100 via the communication line 401. In other words, the program is transmitted in the form of a data signal carried on a carrier wave via the communication line 401. Namely, the program can be distributed as a computer-readable computer program product assuming any of various modes including a storage medium and a data signal (carrier wave).

As long as functions characterizing the present invention remain intact, the present invention is in no way limited to structural details of the embodiment described above. In addition, the embodiment and variations thereof described above may be adopted in any combination.

The disclosure of the following priority application is herein incorporated by reference:
Japanese Patent Application No. 2011-7787 filed Jan. 18, 2011.

1. An image processing apparatus, comprising:
a luminance/chromaticity calculation unit that calculates a luminance and a chromaticity for each pixel of pixels making up image data, based upon a value indicated for the pixel;
a plane calculation unit that determines through arithmetic operation a plane containing coordinates of the pixel in a raw data space;
an intersection point calculation unit that ascertains, through calculation, an intersection point at which an achromatic locus and the plane intersect each other in the raw data space;
an intersection point chromaticity calculation unit that calculates a chromaticity at the intersection point; and
a conversion unit that converts the chromaticity at the pixel to a chromaticity close to a chromaticity of achromatic color if the chromaticity at the pixel is close to the chromaticity at the intersection point.

2. An image processing apparatus according to claim 1, further comprising:
a locus determining unit that determines the achromatic locus in the raw data space.

3. An image processing apparatus according to claim 1, further comprising:
a display control unit that brings up image data, made up with pixels having undergone conversion via the conversion unit, on display at a display device.

4. An image processing program product containing an image processing program that enables a computer to execute:
a luminance/chromaticity calculation step in which a luminance and a chromaticity are calculated for each pixel of pixels making up image data based upon a value indicated for the pixel;
a plane calculation step in which a plane containing coordinates of the pixel in a raw data space is calculated through arithmetic operation;
an intersection point calculation step in which an intersection point at which an achromatic locus and the plane intersect each other in the raw data space is ascertained through calculation;
an intersection point chromaticity calculation step in which a chromaticity at the intersection point is calculated; and
a conversion step in which the chromaticity at the pixel is converted to a chromaticity close to a chromaticity of achromatic color if the chromaticity at the pixel is close to the chromaticity at the intersection point.

5. An image processing program product according to claim 4, wherein:
the image processing program further enables a locus determining step in which the achromatic locus in the raw data space is determined

6. An image processing program product according to claim 4, wherein:
the image processing program further enables a display control step in which image data, made up with pixels having undergone conversion through the conversion step, are brought up on display at a display device.
